(19) United States
(12) Patent Application Publication
(10) Pub. No.: US 2026/0057612 A1
(43) Pub. Date: Feb. 26, 2026

(54) INFORMATION PROCESSING DEVICE, INFORMATION PROCESSING METHOD, AND STORAGE MEDIUM

(71) Applicant: Sony Group Corporation, Tokyo (JP)

(72) Inventor: Yoshinori OHASHI, Tokyo (JP)

(73) Assignee: Sony Group Corporation, Tokyo (JP)

(21) Appl. No.: 19/105,658

(22) PCT Filed: Jul. 11, 2023
(86) PCT No.: PCT/JP2023/025571

§ 371 Date: Feb. 21, 2025

(30) Foreign Application Priority Data
Aug. 30, 2022 (JP) 2022-136829

(51) Int. Cl. G06T 17/05; G06T 3/4007; G06T 3/60; G06T 5/50

(52) U.S. Cl. CPC G06T 17/05; G06T 3/4007; G06T 3/60; G06T 5/50; G06T 2207/20221

(57) ABSTRACT

Provided are an information processing device, an information processing method, and a storage medium capable of visually correcting geographic coordinate information of point cloud data used for position estimation using two-dimensional map data. The information processing device including a control unit that performs: processing of superimposing and displaying a second image generated from point cloud data including feature point data of an object in a real space on a first image generated on the basis of outer circumferential line data of an object acquired from two-dimensional map data of the real space; and processing of updating geographic coordinate information of the point cloud data on the basis of a result of a matching operation of the second image with the first image.

### TECHNICAL FIELD

The present disclosure relates to an information processing device, an information processing method, and a storage medium.

### BACKGROUND ART

In recent years, various techniques for fusing a real space and a virtual space have been developed. For example, an augmented reality (AR) technique for superimposing and displaying a virtual object on a real space in a state where a user can visually recognize the real space in front of the user has been developed. Examples of a display device that provides augmented reality include an optically transmissive head mounted display (HMD).

Furthermore, a virtual object is associated with a specific location in a real space, and a specific virtual object is superimposed and displayed at the specific location. Regarding a positioning technique of the real space, for example, Patent Document 1 below discloses a positioning technique that performs object recognition on a captured image obtained by capturing an image of the real space and estimates a position of the image (that is, a position of a camera that has captured the image) from a position and a size of a landmark in the image.

### CITATION LIST

### Patent Document

Patent Document 1: Japanese Patent Application Laid-Open No. 2021-174289

### SUMMARY OF THE INVENTION

### Problems to be Solved by the Invention

As a recent position estimation technique, there is a visual positioning system (VPS) technique for performing position estimation using point cloud data including a group of feature points of an object in a real space. However, in a case where a global positioning system (GPS) is used to acquire geographic coordinate information associated with the point cloud data, an error in units of meters occurs, and accuracy is not sufficient as a position estimation technique when augmented reality is provided. If a deviation occurs between the object in the real space and the virtual object superimposed and displayed on the object, the realistic feeling is reduced, leading to impairment of the user experience. The correction of the geographic coordinate information requires a worker to go to a site and directly adjust a display position of the virtual object with respect to the real space, which takes time and labor.

Therefore, the present disclosure proposes an information processing device, an information processing method, and a storage medium capable of visually correcting geographic coordinate information of point cloud data used for position estimation using two-dimensional map data.

### Solutions to Problems

According to the present disclosure, there is provided an information processing device including a control unit that performs: processing of superimposing and displaying a second image generated from point cloud data including feature point data of an object in a real space on a first image generated on the basis of outer circumferential line data of an object acquired from two-dimensional map data of the real space; and processing of updating geographic coordinate information of the point cloud data on the basis of a result of a matching operation of the second image with the first image.

Furthermore, according to the present disclosure, provided is an information processing method including: by a processor, superimposing and displaying a second image generated from point cloud data including feature point data of an object in a real space on a first image generated on the basis of outer circumferential line data of an object acquired from two-dimensional map data of the real space; and updating geographic coordinate information of the point cloud data on the basis of a result of a matching operation of the second image with the first image.

Furthermore, according to the present disclosure, provided is a storage medium storing a program for causing a computer to function as a control unit that performs: processing of superimposing and displaying a second image generated from point cloud data including feature point data of an object in a real space on a first image generated on the basis of outer circumferential line data of an object acquired from two-dimensional map data of the real space; and processing of updating geographic coordinate information of the point cloud data on the basis of a result of a matching operation of the second image with the first image.

### BRIEF DESCRIPTION OF DRAWINGS

FIG. 1 is a diagram illustrating a configuration example of a point cloud data update system according to an embodiment of the present disclosure.

FIG. 2 is a diagram illustrating an example of a map image according to the present embodiment.

FIG. 3 is a diagram illustrating an example of a point cloud image in which point cloud data is plotted on a horizontal plane.

FIG. 4 is a diagram illustrating an example of superimposing display (superimposition result) of a map image and a point cloud image according to the present embodiment.

FIG. 5 is a diagram illustrating an example in which a superimposition result is enlarged and displayed, and a pin is hit on an arbitrary place of a point cloud image to be matched with an arbitrary place of a map image.

FIG. 6 is a diagram illustrating an example in which a superimposition result is enlarged and displayed, and a pin is hit on an arbitrary place of a point cloud image to be matched with an arbitrary place of a map image.

FIG. 7 is a diagram for explaining updating of Geo Pose and Pose of key frames located between a plurality of pins according to the present embodiment.

FIG. 8 is a flowchart illustrating an example of a flow of a point cloud data update process according to the present embodiment.

### MODE FOR CARRYING OUT THE INVENTION

Hereinafter, preferred embodiments of the present disclosure will be described in detail with reference to the accompanying drawings. Note that, in the present specification and drawings, configuration elements having substantially the same functional configuration are denoted by the same reference signs, and redundant description is omitted.

Furthermore, a description will be given in the following order.
1. Outline of point cloud data update system according to embodiment of present disclosure
2. Configuration example
2-1. System configuration example
2-2. Configuration example of information processing device 10
3. Example of operation processing
4. Modification
5. Additional notes

### 1. Outline of Point Cloud Data Update System According to Embodiment of Present Disclosure

As an embodiment of the present disclosure, a mechanism for visually correcting geographic coordinate information of point cloud data used for position estimation using two-dimensional map data will be described.

### (Review of Problems)

The point cloud data used in the VPS technique for estimating a position of an imaging point on the basis of a captured image is generated by a group of feature points of an object extracted from the captured image obtained by capturing a real space. In the point cloud data, as geographic coordinate information associated with the group of feature points, position information (information of latitude and longitude, and an elevation) of the imaging point of the captured image of an extraction source of the group of feature points is used. However, in a case where the position information is GPS information, an error in units of meters may occur. The position estimation by the VPS technique using the point cloud data in a state where there is an error in units of meters in the associated geographic coordinate information has insufficient accuracy as a position estimation technique when providing augmented reality. The correction of the geographic coordinate information requires a worker to go to a site and directly adjust a display position of the virtual object with respect to the real space, which takes time and labor. Furthermore, it is conceivable to improve the accuracy of the geographic coordinate information by matching the point cloud data with the existing three-dimensional geographic space data, but at the present time, the three-dimensional geographic space data is not sufficiently prepared, and a place where the matching can be performed is limited. Furthermore, there is also a simultaneous localization and mapping (SLAM) technique as a position estimation technique, but such a technique alone cannot associate point cloud data with geographic coordinate information.

When the accuracy of the position estimation is low, in a display device used by a user when the augmented reality is provided, a deviation occurs between an object in the real space and a virtual object superimposed and displayed on the object, and the realistic feeling of the augmented reality decreases. The reduction in realistic feeling leads to impairment of user experience.

Therefore, in the present disclosure, it is possible to visually correct the geographic coordinate information of the point cloud data used for the position estimation using two-dimensional map data.

When the accuracy of position estimation using the VPS technique is improved and the position and posture (specifically, latitude, longitude, an elevation, an azimuth angle, and an elevation angle of the display device used by the user) of the user is accurately estimated at the time of providing augmented reality, the display device can accurately superimpose and display a virtual object associated with geographic coordinate information such as latitude and longitude on an object in the real space without discomfort. Note that the virtual object is, for example, a 2D image or a 3DCG. Furthermore, the virtual object may be either a still image or a moving image. For example, the virtual object may be a CG animation of fish swimming around a specific building in the real space, or may be a poster image that appears to be pasted on a specific building. Furthermore, the object in the real space is not limited to an artificial object such as a building, a utility pole, or a signboard, and may be a natural object such as a river, a mountain, or a ground.

Furthermore, in an embodiment of the present disclosure, as the two-dimensional map data used for correcting the geographic coordinate information of the point cloud data, use of map data provided by a two-dimensional map data service already corresponding to most of the domestic or foreign regions is assumed. For example, in an embodiment of the present disclosure, two-dimensional map data is acquired from an open database provided by a national administrative agency.

The outline of the point cloud data update system according to the embodiment of the present disclosure has been described above. Next, a configuration example of the point cloud data update system according to the present embodiment will be described with reference to the drawings.

### 2. Configuration Example

### 2-1. System Configuration Example

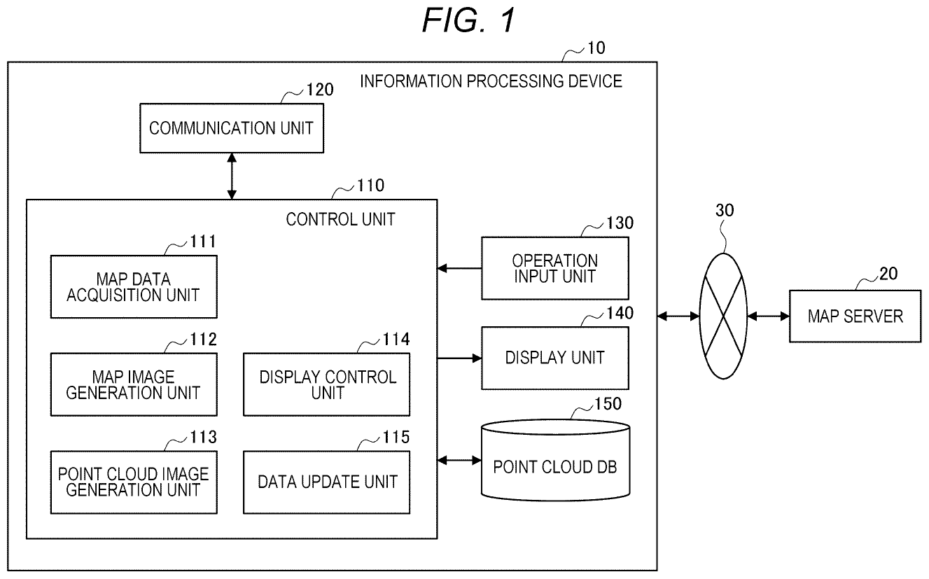

FIG. 1 is a diagram illustrating a configuration example of a point cloud data update system according to an embodiment of the present disclosure. As illustrated in FIG. 1, the point cloud data update system according to the present embodiment includes an information processing device 10 and a map server 20. The information processing device 10 and the map server 20 are communicably connected via a network 30.

The map server 20 is a server of a service that provides two-dimensional map data of a real space. The two-dimensional map data is data in which map drawing information is associated with latitude and longitude. For example, the map server 20 is assumed to be an open database provided by the Geospatial Information Authority of Japan, which is one of the national administrative agencies.

The information processing device 10 has a function of updating geographic coordinate information of point cloud data for the VPS. A specific configuration example of the information processing device 10 will be described next.

### 2-2. Configuration Example of Information Processing Device 10

As illustrated in FIG. 1, the information processing device 10 includes a control unit 110, a communication unit 120, an operation input unit 130, a display unit 140, and a point cloud database (DB) 150.

### (Communication Unit 120)

The communication unit 120 includes a transmission unit that transmits data to an external device and a reception unit that receives data from the external device. The communication unit 120 is communicably connected to the external device or the network 30 using, for example, a wired/wireless local area network (LAN), Wi-Fi (registered trademark), Bluetooth (registered trademark), a mobile communication network (Long Term Evolution (LTE), fourth generation mobile communication system (4G), and fifth generation mobile communication system (5G)), or the like.

For example, the communication unit 120 according to the present embodiment can acquire two-dimensional map data from the map server 20 via the network 30.

### (Operation Input Unit 130 and Display Unit 140)

The operation input unit 130 receives an operation input by the user and outputs input information to the control unit 110. Furthermore, the display unit 140 displays various operation screens. The display unit 140 may be a display panel such as a liquid crystal display (LCD) or an organic electro luminescence (EL) display. The operation input unit 130 and the display unit 140 may be provided integrally. For example, the operation input unit 130 may be a touch sensor stacked on the display unit 140 (for example, a panel display).

### (Point Cloud DB 150)

The point cloud DB 150 stores a set of key frames (also referred to as point cloud data) including a feature point data group extracted from a captured image obtained by capturing a real space, geographic coordinate information of an imaging point, and virtual space position information. The virtual space position information is position information in the virtual space constructed by the point cloud data. The virtual space can also be said to be a three-dimensional map space that is a digital twin of the real space. Furthermore, the point cloud data according to the present embodiment is point cloud data used for the VPS that estimates the position of the imaging point from the captured image, and the virtual space position information corresponds to Pose (position and attitude in units of meters) of the VPS coordinate system. Pose may be, for example, position information indicating a position in an area of about 10 m to 100 m square with a certain geographical location as an origin. Furthermore, the geographic coordinate information of the imaging point is, for example, Geo Pose (latitude, longitude, an elevation, an azimuth angle, and an elevation angle). In the initial state, for example, information acquired by the GPS at the time of image capturing is registered in Geo Pose. An example of a data configuration of the key frame stored in the point cloud DB 150 is illustrated in the following Table 1.

TABLE 1
Key frame

| | |
|---|---|
| ID | . . . |
| Geo Pose | Latitude, longitude, elevation, |
| | azimuth angle, and elevation angle |
| Pose | Position and attitude in units of |
| | meters |
| Feature point data 1 | X, Y, and Z in screen coordinates |
| | Color information or the like |
| | around feature point |
| . | |
| . | |
| . | |
| Feature point data N | |

As described above, in the point cloud DB 150, the geographic coordinate information (Geo Pose) that is the position information of the real space, and the virtual space position information (Pose) are associated with each other. By using the point cloud DB 150, at the time of providing augmented reality, position and attitude information (latitude, longitude, an elevation, an azimuth angle, and an elevation angle) of the display device is estimated from feature point data extracted from a captured image obtained by imaging the periphery by a camera provided in the display device. That is, position measurement using the VPS technique is performed. As a result, the position and attitude information of the virtual camera in the virtual space corresponding to the real space is also acquired, and the display position and the display attitude of the virtual object that can be superimposed and displayed on the object in the real space, disposed in the virtual space to be the digital twin in the real space, can be appropriately acquired.

The point cloud DB 150 may be stored in a storage unit (not illustrated) of the information processing device 10. The storage unit is realized by a read only memory (ROM) that stores programs, operation parameters, and the like used for processing of the control unit 110, and a random access memory (RAM) that temporarily stores parameters and the like that change appropriately.

Furthermore, the point cloud DB 150 is not limited to the configuration stored in the information processing device 10, and may be stored in a data server on a network.

### (Control Unit 110)

The control unit 110 functions as an arithmetic processing device and a control device, and controls the overall operation in the information processing device 10 according to various programs. The control unit 110 is realized by, for example, an electronic circuit such as a central processing unit (CPU) or a microprocessor. Furthermore, the control unit 110 may include a read only memory (ROM) that stores programs, operation parameters, and the like to be used, and a random access memory (RAM) that temporarily stores parameters and the like that change appropriately.

Furthermore, the control unit 110 also functions as a map data acquisition unit 111, a map image generation unit 112, a point cloud image generation unit 113, a display control unit 114, and a data update unit 115.

Specifically, the control unit 110 causes the map data acquisition unit 111 to acquire necessary two-dimensional map data from the map server 20, and causes the map image generation unit 112 to generate a two-dimensional map image (an example of a first image) at a designated scale using the two-dimensional map data. The necessary two-dimensional map data is geospatial information including at least a geographical range indicated by geographic coordinate information (specifically, latitude and longitude) of the point cloud data to be updated. In the present embodiment, the map data acquisition unit 111 can acquire the geospatial information in a vector tile format from the map server 20. The vector tile format is a method of expressing a map by digitized information (vector) of points, lines, and planes, information regarding drawing such as colors, and the like. Furthermore, in the geospatial information in the vector tile format used in the present embodiment, information of various objects such as roads, railways, and buildings is described by text. The map data acquisition unit 111 acquires outer circumferential line data of a building (an example of an object) used for generating a map image from the geospatial information (two-dimensional map data) in the vector tile format acquired from the map server 20.

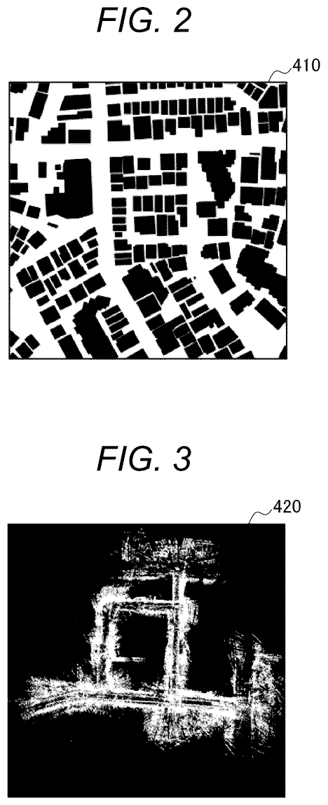

The map image generation unit 112 generates a two-dimensional map image on a designated scale on the basis of the outer circumferential line data of a building (an example of an object). The scale may be arbitrarily designated by the user or may be set in advance. For example, the map image generation unit 112 may generate a map image in which the inside of outer circumferential line data of a building is filled in black and the outside is filled in white. FIG. 2 is a diagram illustrating an example of a map image according to the present embodiment. As illustrated in FIG. 2, in the map image 410, the inside of the outer circumferential line of the building is filled in black, and the outside of the outer circumferential line of the building is drawn in white. Note that, in the geospatial information in the vector tile format, there is a case where a line segment constituting an outer circumferential line of one building is divided into a plurality of objects. Therefore, the map image generation unit 112 may perform a process of comparing vertex positions of the respective objects and merging the vertexes as an outer circumferential line of one building in a case where the vertexes coincide with each other, and then perform filling.

Returning to FIG. 1, the description of the configuration will be continued. The point cloud image generation unit 113 generates a point cloud image (an example of a second image) from the point cloud data (a set of key frames) stored in the point cloud DB 150. More specifically, the point cloud image generation unit 113 generates a two-dimensional point cloud image by plotting the point cloud data on a horizontal plane. Here, since the position of the feature point of each key frame used to generate the point cloud image is stored in screen coordinates for each key frame (captured image), the point cloud image generation unit 113 multiplies the attitude of the key frame by the position of the key frame to convert the position to a position in world coordinates. The world coordinates are coordinates common to the respective key frames used to generate the point cloud image with respect to screen coordinates (local coordinates) unique to the respective key frames.

Then, the point cloud image generation unit 113 rotates all the feature points such that the north direction is the upward direction of the image, and plots the feature points on a horizontal plane. FIG. 3 is a diagram illustrating an example of a point cloud image in which point cloud data is plotted on a horizontal plane. In a point cloud image 420 illustrated in FIG. 3, each feature point (point cloud) is drawn in white. Since the point cloud tends to appear concentrated on the wall surface of the building, and the other side of the wall is not extracted, an image similar to the outer circumferential line of the building can be generated as the point cloud image 420.

Returning to FIG. 1, the description of the configuration will be continued. The display control unit 114 performs control to superimpose and display the point cloud image generated by the point cloud image generation unit 113 on the map image generated by the map image generation unit 112 on the display unit 140. Here, the display control unit 114 displays the latitude and longitude of the origin of the point cloud image in accordance with the latitude and longitude of the map image. Note that the direction is generated such that the north direction is the upward direction of the image in both the point cloud image and the map image. Furthermore, the latitude and longitude of the origin of the point cloud image can be calculated by the point cloud image generation unit 113 on the basis of the Geo Pose of the key frame.

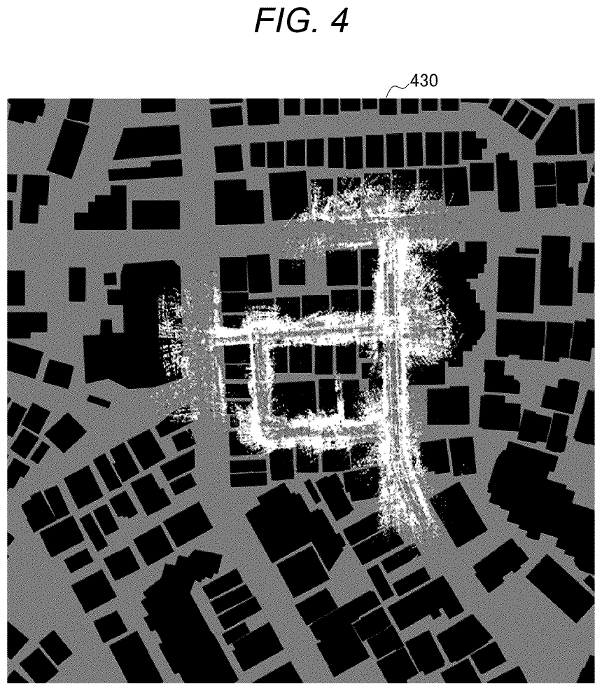

The data update unit 115 performs processing of updating (correcting) the geographic coordinate information of the point cloud data on the basis of the result of a matching operation of the superimposed and displayed point cloud image with the map image by the user. The matching operation includes an adjustment operation of at least a position (display position of the point cloud image) or rotation (display direction of the point cloud image) with respect to the point cloud image by the user so that the point cloud drawn in the point cloud image matches the shape (outer circumferential line) of the object drawn in the map image. As described above, in the initial state, for example, GPS information is registered in Geo Pose of the key frame, and thus, there is a possibility that an error in units of meters occurs. The user visually confirms whether the point cloud drawn in the point cloud image and the shape (outer circumferential line) of the object drawn in the map image match, and performs an operation of moving the display position of the point cloud image or an operation of rotating the point cloud image so as to match in a case where the point cloud and the shape do not match. FIG. 4 is a diagram illustrating an example of superimposing display (superimposing result) of a map image and a point cloud image according to the present embodiment. As illustrated in FIG. 4, on the display screen 430, the point cloud drawn in white is adjusted to match the outer circumferential line drawn on the map image. Note that the adjustment operation may be an adjustment operation for any one place included in the point cloud image, or may be an adjustment operation for a plurality of places.

The data update unit 115 calculates the latitude and longitude and the azimuth angle of the origin of the point cloud image after adjustment from the operation amount (shift amount) in the adjustment, and updates Geo Pose (an example of geographic coordinate information) of each key frame on the basis of the positional relationship with the origin. More specifically, the data update unit 115 can first update Geo Pose of a key frame corresponding to an arbitrary place (for example, an origin, a characteristic corner place, a place on which a pin to be described later is applied, or the like.) of the point cloud image, and then calculate and update Geo Pose of other key frames (all the key frames stored in the point cloud DB 150) on the basis of the positional relationship with the key frame. Hereinafter, description will be made using a calculation formula.

When PP0 (public position), which is Pose of a certain key frame 0 (key frame corresponding to an arbitrary place of the point cloud image) of the point cloud DB 150, is associated with a specific Geo Pose (latitude, longitude, an elevation, and an azimuth angle) by the adjustment operation of the point cloud image, the data update unit 115 first converts the latitude, longitude, elevation, and azimuth angle to a position and an attitude of a global Euclidean space. In the present embodiment, coordinate mutual conversion between Geo Pose (geographic coordinate information including latitude, longitude, an elevation, and an azimuth angle) and Pose (position coordinates and attitude of the virtual space) is performed through conversion into a position: PG (x, y, z) and an attitude (rotation: RG) of Euclidean space on a global scale.

The conversion of Geo Pose (latitude, longitude, an elevation, and an azimuth angle) associated with PP0 of the key frame 0 into a position: PG0 (x, y, z) and an attitude (rotation: RG0) of Euclidean space on a global scale is performed by, for example, the following Formula 1. The data update unit 115 may generate rotation information designating only a yaw component as an example of the attitude information of the virtual space.

$$\begin{matrix}[ Mathematical formula 1 ] & \\ \begin{matrix}RG 0 = Quaternion ( 0 , \frac{azimuth}{360} * 2 π , 0 ) \\ PG 0. y = elevation \\ PG 0. z = latitude * 110.94297 * 1000 \\ PG 0. x = \frac{longitude}{360} * cos ( \frac{latitude}{360} * 2 π ) * 2 π * 6378137\end{matrix} & ( Formula 1 )\end{matrix}$$

Next, the data update unit 115 obtains Geo Pose (latitude1, longitude1, elevation1, azimuth1) for Pose (PP1) of another key frame 1 of the point cloud DB 150 by the following Formula 2 using PP0, PG0, and RG0.

$$\begin{matrix}[ Mathematical formula 2 ] & \\ \begin{matrix}Δ {R}_{g \to p} = RG {0}^{- 1} * RP 0. getYaw ( ) \\ PG 1 = PG 0 + Δ {{R}_{g \to p}}^{- 1} * ( PP 1 - PP 0 ) \\ elevation 1 = PG 1. y \\ latitude 1 - PG 1. z / ( 110.94297 * 1000 ) \\ longitude 1 = PG 1. x * 360 / ( cos ( \frac{latitude}{360} * 2 π ) * 2 π * 6378137 ) \\ azimuth 1 = azimith + ( RG {0}^{- 1} * PR 1 ) . getYawEuler ( )\end{matrix} & ( Formula 2 )\end{matrix}$$

Then, the data update unit 115 updates (corrects) the Geo Pose in the initial state of the key frame 1 to the Geo Pose calculated by the above Formula 2. The data update unit 115 applies the above processing to all the key frames in the point cloud DB 150. As a result, the data update unit 115 can update the geographic coordinate information in the initial state of the point cloud data on the basis of the result of the adjustment operation and eliminate the error in the geographic coordinate information. Note that the above-described calculation method is an example, and the present disclosure is not limited thereto. The data update unit 115 only needs to be able to update the geographic coordinate information in the initial state of the point cloud data on the basis of the result of the adjustment operation.

Furthermore, the method of the operation of adjusting the position rotation of the point cloud image is not limited to the example described with reference to FIG. 4. Hereinafter, some other methods of the adjustment operation will be described.

### Enlarged Display of Superimposition Result

The user may instruct to change the display scale in order to more accurately match the point cloud image and the map image. Specifically, the user may instruct to enlarge and display the superimposition result. Since the map data used for generating the map image is acquired in a vector tile format, the map image generation unit 112 can draw the outer circumferential line in accordance with the enlargement scale without blunting the edge of the building. Note that, in a case where the map data is not in the vector tile format but is an image such as a satellite picture, the image becomes coarse by enlargement, and the position of the edge of the building cannot be correctly recognized. Therefore, how far the map data can be enlarged depends on the resolution of the image.

### Matching at a Plurality of Places

The matching of the point cloud image with the map image may be performed at a plurality of places instead of one place. This is because, in the generation of the point cloud data, an error may occur in the point cloud data itself due to incorrect determination of the connection of the key frames, incorrect estimation of the scale, or the like, and it may be insufficient to perform the matching only at one place. The matching of the plurality of places is performed by, for example, enlarging and displaying the plurality of places, precisely adjusting the position or rotation of the point cloud image, and then striking a pin. When hitting a plurality of pins, not all the pins are manually hit by the user, but at least some of the pins may be automatically hit by the data update unit 115. For example, the data update unit 115 may automatically pin a characteristic corner portion of the point cloud. Furthermore, the data update unit 115 may hit any number of pins.

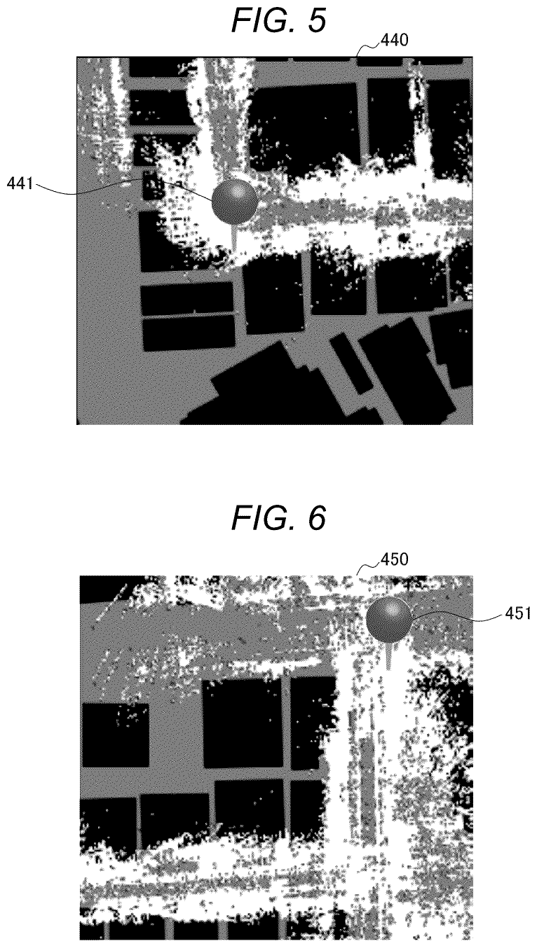

FIGS. 5 and 6 are diagrams illustrating an example in which a plurality of places of the superimposition result illustrated in FIG. 4 is enlarged and displayed, and a pin is struck on an arbitrary place of the point cloud image to be matched with an arbitrary place of the map image. In FIG. 5, a pin 441 is struck at an arbitrary position in the enlarged display image 440, and in FIG. 6, a pin 451 is struck at an arbitrary position in the enlarged display image 450. The data update unit 115 calculates geographic coordinate information at the place where each pin is struck, and updates Geo Pose of the corresponding key frame. Then, the data update unit 115 updates the Geo Pose of the key frame located between the pins using linear interpolation. Moreover, the data update unit 115 can also eliminate the error of the point cloud data itself by updating the key frame Pose located between the pins.

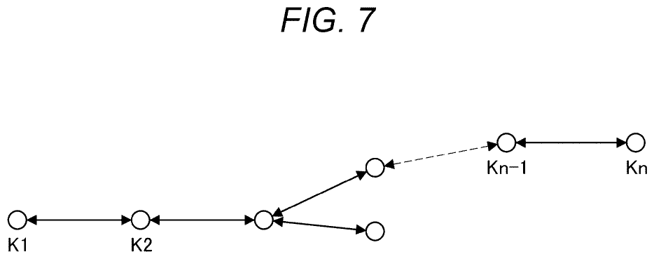

Updating of Geo Pose and Pose by the matching at a plurality of places will be specifically described with reference to FIG. 7. FIG. 7 is a diagram for describing update of Geo Pose and Pose of a key frame located between a plurality of pins according to the present embodiment.

First, as a premise, the point cloud DB 150 according to the present embodiment also stores link information indicating connection of the respective key frames. An example of the link information is illustrated in the following Table 2.

TABLE 2
Key frame link

| | |
|---|---|
| Link source ID | Key frame ID |
| Link destination ID | Key frame ID |
| ΔPose | Differences in position and |
| | attitude between key frames |

In the example illustrated in FIG. 7, it is assumed that a pin is struck on each of the key frame K1 and the key frame Kn. That is, the data update unit 115 first updates Geo Pose: GP1 of the key frame K1 to GP1′ calculated on the basis of the position specified by the pin, and updates Geo Pose: GPn of the key frame Kn to GPn′ calculated on the basis of the position specified by the pin. Next, the data update unit 115 refers to the link information, specifies the key frames K2 to Kn−1 located between the pinned key frames, and updates the Geo Pose of these key frames. As an example, the data update unit 115 obtains ΔGPm obtained by linearly interpolating the difference ΔGPn between GPn and GPn′ according to the distance from the difference ΔGP1 between GP1 and GP1′, and applies ΔGPm to Geo Pose of the key frame Km to update it. The key frame Km indicates an arbitrary key frame among the key frame K2 to the key frame Kn−1. Furthermore, the distance is a distance from the key frame K1 to the key frame Km and a distance from the key frame Km to the key frame Kn. Then, the data update unit 115 updates the Pose according to the new Geo Pose for the key frame K in which the Geo Pose has been updated. In this way, the error of the point cloud data itself can also be corrected.

Although the configuration of the information processing device 10 has been specifically described above, the configuration of the information processing device 10 according to the present disclosure is not limited to the example illustrated in FIG. 1. For example, the information processing device 10 may be implemented by a plurality of devices. Furthermore, at least a part of the functions of the information processing device 10 may be implemented by a server.

### 3. Example of Operation Processing

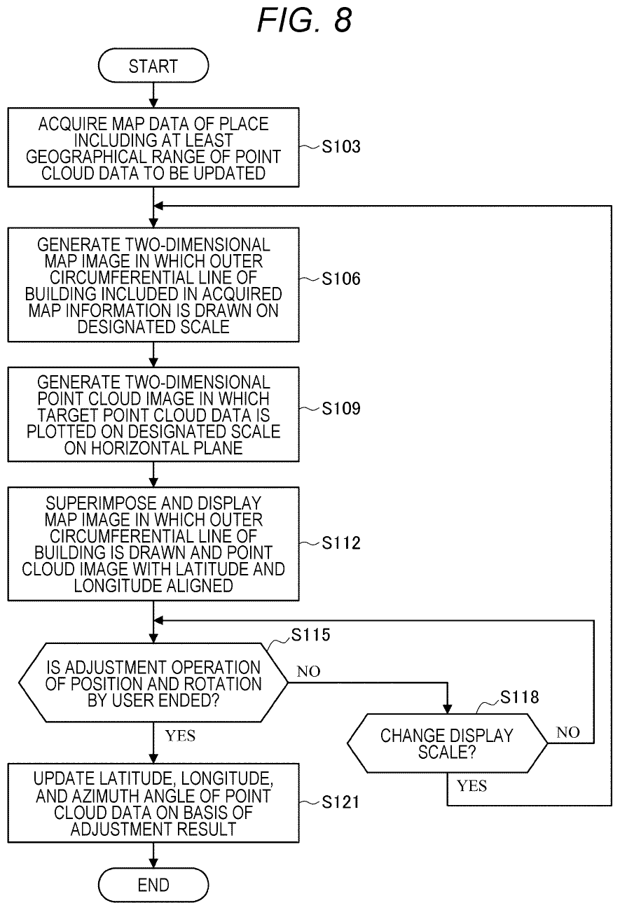

Next, an operation processing example according to the present embodiment will be described with reference to FIG. 8. FIG. 8 is a flowchart illustrating an example of a flow of a point cloud data update process according to the present embodiment.

As illustrated in FIG. 8, first, the control unit 110 of the information processing device 10 acquires map data of a place including at least the geographical range of the point cloud data to be updated from the map server 20 (step S103). For example, the control unit 110 acquires map data of a place matching the latitude and longitude of the point cloud data.

Next, the control unit 110 generates a two-dimensional map image in which the outer circumferential line of the building included in the acquired map information is drawn on a designated scale (step S106).

Next, the control unit 110 generates a two-dimensional point cloud image in which target point cloud data is plotted on a designated scale on a horizontal plane (step S109).

Subsequently, the control unit 110 superimposes and displays the map image in which the outer circumferential line of the building is drawn and the point cloud image with the latitude and longitude aligned (step S112).

Next, the control unit 110 receives a matching operation (adjustment operation of a position and a rotation) of the point cloud image by the user from the operation input unit 130, and in a case where the operation is ended (step S115/Yes), the control unit 110 updates the latitude, longitude, and azimuth angle of the point cloud data on the basis of a result of the adjustment (step S121). The adjustment operation of the position and the rotation may be performed by a touch operation, a mouse operation, or a key input.

Furthermore, in a case where the instruction to change the display scale is given (step S118/Yes), the control unit 110 may generate a map image and a point cloud image on a new designated scale (for example, enlargement scale), and perform superimposition display (steps S106 to S112).

The flow of the point cloud data update process according to the present embodiment has been specifically described above. Note that the operation processing illustrated in FIG. 8 is an example, and the present disclosure is not limited thereto.

### 4. Modification

Each image to be superimposed and displayed is not limited to an image viewed from a horizontal plane, and the control unit 110 may generate and superimpose and display an image with a changed angle. As a result, the user can correct not only the latitude and longitude, and the azimuth angle of the key frame but also the elevation or the elevation angle. For example, by the control unit 110 generating and superimposing each image from a viewpoint obliquely upward with respect to the horizontal plane, the user can easily confirm whether the ground contact surface of the building appearing in the point cloud coincides with the outer circumferential line of the building in the map image. Furthermore, the control unit 110 generates an image of an angle viewed from the vertical direction, and superimposes and displays the position of the ground in the point cloud image on the ground in accordance with the position of the ground in the map image, so that the user can also adjust the height direction (that is, correct the elevation). However, in this case, it is necessary to include the elevation information of the ground in the map data as a premise.

Furthermore, in addition to the building, information such as a road and a river may be added to the map image.

Furthermore, the control unit 110 may generate a 3D mesh from the point cloud data and superimpose the 3D mesh on a two-dimensional map image.

Furthermore, the geographic coordinate information of each key frame stored in the point cloud DB 150 may be latitude, longitude, and an azimuth angle, or may be information indicating latitude, longitude, and an azimuth angle. For example, data obtained by dividing the latitude by two may be used as the information indicating the latitude.

Furthermore, in the above-described embodiment, the map image in which the inside of the outer circumferential line of the building is painted black is generated by the control unit 110, but the present disclosure is not limited thereto. The control unit 110 may generate a map image in which the inside of the outer circumferential line of the building is painted in another color, or may generate a map image in which the outer circumferential line of the building is drawn without painting.

### 5. Additional Notes

The preferred embodiment of the present disclosure has been described above in detail with reference to the accompanying drawings, but the present technology is not limited to such an example. It is obvious that those with ordinary skill in the technical field of the present disclosure can conceive various alterations or corrections within the scope of the technical idea recited in the claims, and it is naturally understood that these alterations or corrections also fall within the technical scope of the present disclosure.

Furthermore, it is also possible to create one or more computer programs for causing hardware such as the CPU, the ROM, and the RAM built in the information processing device 10 described above to exhibit the functions of the information processing device 10. Furthermore, a computer-readable storage medium that stores the one or more computer programs is also provided.

Furthermore, the effects described in the present specification are merely exemplary or illustrative, and not restrictive. That is, the technology according to the present disclosure can exhibit other effects apparent to those skilled in the art from the description of the present specification, in addition to the effects described above or instead of the effects described above.

Note that, the present technology can also have the following configurations.

(1)

An information processing device including a control unit that performs:
processing of superimposing and displaying a second image generated from point cloud data including feature point data of an object in a real space on a first image generated on the basis of outer circumferential line data of an object acquired from two-dimensional map data of the real space; and
processing of updating geographic coordinate information of the point cloud data on the basis of a result of a matching operation of the second image with the first image.
   (2)

The information processing device according to (1) described above, in which the matching operation includes an adjustment operation of at least a position or rotation with respect to the second image performed by a user so that a point cloud drawn in the second image matches a shape of an object drawn in the first image.

(3)

The information processing device according to (2) described above, in which the adjustment operation includes an adjustment operation for a plurality of places included in the second image.

(4)

The information processing device according to (1) or (2) described above, in which the geographic coordinate information includes at least information indicating latitude, longitude, and an azimuth angle.

(5)

The information processing device according to (4) described above, in which the point cloud data is a set of key frames including a group of feature point data extracted from a captured image, the geographic coordinate information, and virtual space position information.

(6)

The information processing device according to (5) described above, in which the control unit generates the second image from the set of key frames.

(7)

The information processing device according to (6) described above, in which the control unit generates the second image by converting a position of each feature point included in the group of the feature point data of each of the key frames from screen coordinates of each captured image into world coordinates and drawing a point cloud on a horizontal plane.

(8)

The information processing device according to any one of (5) to (7) described above, in which the control unit calculates latitude and longitude of an origin of the second image, and superimposes and displays the second image such that the calculated latitude and longitude match latitude and longitude of the first image.

(9) The information processing device according to any one of (5) to (8) described above, in which the control unit updates the geographic coordinate information included in each of the key frames on the basis of a result of the matching operation.
(10)

The information processing device according to (7) described above, in which the control unit calculates and updates latitude and longitude of each of the key frames corresponding to an arbitrary position of the second image after adjustment on the basis of a shift amount of a position or a rotation of the second image by the matching operation.

(11)

The information processing device according to any one of (5) to (10) described above, in which the control unit calculates and updates latitude and longitude of each of the key frames on the basis of a result of the matching operation performed on a plurality of places of the second image.

(12)

The information processing device according to (11) described above, in which the control unit calculates and updates, using linear interpolation, the latitude and longitude of one or more key frames located between the key frames corresponding to the plurality of places where the matching operation has been performed.

(13)

The information processing device according to any one of (1) to (12) described above, in which the point cloud data includes data used when position estimation is performed by a visual positioning system (VPS).

(14)

The information processing device according to any one of (1) to (13) described above, in which the two-dimensional map data includes geospatial information in a vector tile format provided from an external two-dimensional map data service.

(15)

The information processing device according to any one of (1) to (14) described above, in which the object in the real space includes at least a building, a road, or a river.

(16)

The information processing device according to any one of (1) to (15) described above, in which the control unit generates the first image and the second image from a viewpoint from an angle other than an angle at which the first image and the second image are viewed from a horizontal plane.

(17)

The information processing device according to any one of (1) to (16), in which the geographic coordinate information includes information indicating latitude, longitude, an azimuth angle, an elevation, and an elevation angle.

(18)

The information processing device according to any one of (1) to (17) described above, in which as the geographic coordinate information of the point cloud data, geographic coordinate information of an imaging point of a captured image from which each piece of feature point data is extracted is used as an initial state.

(19)

An information processing method including:
by a processor,
superimposing and displaying a second image generated from point cloud data including feature point data of an object in a real space on a first image generated on the basis of outer circumferential line data of an object acquired from two-dimensional map data of the real space; and
updating geographic coordinate information of the point cloud data on the basis of a result of a matching operation of the second image with the first image.
   (20)

A storage medium storing a program for causing a computer to function as a control unit that performs:
processing of superimposing and displaying a second image generated from point cloud data including feature point data of an object in a real space on a first image generated on the basis of outer circumferential line data of an object acquired from two-dimensional map data of the real space; and
processing of updating geographic coordinate information of the point cloud data on the basis of a result of a matching operation of the second image with the first image.

### REFERENCE SIGNS LIST

10 Information processing device
110 Control unit
111 Map data acquisition unit
112 Map image generation unit
113 Point cloud image generation unit
114 Display control unit
115 Data update unit
120 Communication unit
130 Operation input unit
140 Display unit
150 Point cloud DB
20 Map server
30 Network

1. An information processing device comprising a control unit that performs:
processing of superimposing and displaying a second image generated from point cloud data including feature point data of an object in a real space on a first image generated on a basis of outer circumferential line data of an object acquired from two-dimensional map data of the real space; and
processing of updating geographic coordinate information of the point cloud data on a basis of a result of a matching operation of the second image with the first image.

2. The information processing device according to claim 1, wherein the matching operation includes an adjustment operation of at least a position or rotation with respect to the second image performed by a user so that a point cloud drawn in the second image matches a shape of an object drawn in the first image.

3. The information processing device according to claim 2, wherein the adjustment operation includes an adjustment operation for a plurality of places included in the second image.

4. The information processing device according to claim 1, wherein the geographic coordinate information includes at least information indicating latitude, longitude, and an azimuth angle.

5. The information processing device according to claim 4, wherein the point cloud data is a set of key frames including a group of feature point data extracted from a captured image, the geographic coordinate information, and virtual space position information.

6. The information processing device according to claim 5, wherein the control unit generates the second image from the set of key frames.

7. The information processing device according to claim 6, wherein the control unit generates the second image by converting a position of each feature point included in the group of the feature point data of each of the key frames from screen coordinates of each captured image into world coordinates and drawing a point cloud on a horizontal plane.

8. The information processing device according to claim 5, wherein the control unit calculates latitude and longitude of an origin of the second image, and superimposes and displays the second image such that the calculated latitude and longitude match latitude and longitude of the first image.

9. The information processing device according to claim 5, wherein the control unit updates the geographic coordinate information included in each of the key frames on a basis of a result of the matching operation.

10. The information processing device according to claim 8, wherein the control unit calculates and updates latitude and longitude of each of the key frames corresponding to an arbitrary position of the second image after adjustment on a basis of a shift amount of a position or a rotation of the second image by the matching operation.

11. The information processing device according to claim 5, wherein the control unit calculates and updates latitude and longitude of each of the key frames on a basis of a result of the matching operation performed on a plurality of places of the second image.

12. The information processing device according to claim 11, wherein the control unit calculates and updates, using linear interpolation, the latitude and longitude of one or more key frames located between the key frames corresponding to the plurality of places where the matching operation has been performed.

13. The information processing device according to claim 1, wherein the point cloud data includes data used when position estimation is performed by a visual positioning system (VPS).

14. The information processing device according to claim 1, wherein the two-dimensional map data includes geospatial information in a vector tile format provided from an external two-dimensional map data service.

15. The information processing device according to claim 1, wherein the object in the real space includes at least a building, a road, or a river.

16. The information processing device according to claim 1, wherein the control unit generates the first image and the second image from a viewpoint from an angle other than an angle at which the first image and the second image are viewed from a horizontal plane.

17. The information processing device according to claim 1, wherein the geographic coordinate information includes information indicating latitude, longitude, an azimuth angle, an elevation, and an elevation angle.

18. The information processing device according to claim 1, wherein as the geographic coordinate information of the point cloud data, geographic coordinate information of an imaging point of a captured image from which each piece of feature point data is extracted is used as an initial state.

19. An information processing method comprising:
by a processor
superimposing and displaying a second image generated from point cloud data including feature point data of an object in a real space on a first image generated on a basis of outer circumferential line data of an object acquired from two-dimensional map data of the real space; and
updating geographic coordinate information of the point cloud data on a basis of a result of a matching operation of the second image with the first image.

20. A storage medium storing a program for causing a computer to function as a control unit that performs:
processing of superimposing and displaying a second image generated from point cloud data including feature point data of an object in a real space on a first image generated on a basis of outer circumferential line data of an object acquired from two-dimensional map data of the real space; and
processing of updating geographic coordinate information of the point cloud data on a basis of a result of a matching operation of the second image with the first image.
